(19) United States
(12) Patent Application Publication
(10) Pub. No.: US 2015/0197306 A1
(43) Pub. Date: Jul. 16, 2015

(54) HANDLEBAR ASSEMBLY FOR A PEDAL-DRIVEN MACHINE

(71) Applicant: Michael L. Denby, Scottsdale, AZ (US)

(72) Inventor: Michael L. Denby, Scottsdale, AZ (US)

(21) Appl. No.: 14/157,256

(22) Filed: Jan. 16, 2014

(51) Int. Cl. B62K 21/12; B62K 21/26

(52) U.S. Cl. CPC B62K 21/125; B62K 21/26

(57) ABSTRACT

A handlebar assembly for a pedal-driven machine includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a first body portion opposing the first hand-gripping portion and a second body portion opposing the second hand-gripping portion, the first body portion is positioned and is shaped to receive so as to resist a leveraging force from a left-hand finger extended from a rider's left hand when on the first hand-gripping portion of the handlebar, and the second body portion is positioned and is shaped to receive so as to resist a leveraging force from a right-hand finger extended from a rider's right hand when on the second hand-gripping portion of the handlebar.

### FIELD OF THE INVENTION

The present invention relates to pedal-driven machines and, more particularly, to handlebar assemblies for use with pedal-driven machines, especially bicycles and stationary pedal-driven exercise machines.

### BACKGROUND OF THE INVENTION

Cyclists, especially competitive cyclists, strive to harness as best as possible the available mechanical advantage of the bicycle in order to go as quickly as possible as efficiently as possible. The total mechanical advantage of a bicycle is the ratio of the driving force of the bicycle to the force on the pedals applied via the rider's legs. To maximize the available mechanical advantage of a bicycle, the leverage between the cyclist and the bicycle must therefore be maximized. This leverage is conventionally maximized by ensuring the cyclist is fitted properly to the bicycle in question, that the length of the pedal crank arms relates to the pedal stroke and leg architecture and body dynamics of the rider in question, and by ensuring that the gear ratio of the bicycle is aligned with the chosen riding conditions. Although cyclists and trainers and other specialists have devoted, and continue to devote, considerable effort toward harnessing the available mechanical advantage from a bicycle, results of these persistent efforts have proven less than satisfactory as they continually fall short of expected outcomes, thereby necessitating continued improvement in the art.

### SUMMARY OF THE INVENTION

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a first body portion opposing the first hand-gripping portion and a second body portion opposing the second hand-gripping portion, the first body portion is positioned and is shaped to receive so as to resist a leveraging force from a left-hand finger extended from a rider's left hand when on the first hand-gripping portion of the handlebar, and the second body portion is positioned and is shaped to receive so as to resist a leveraging force from a right-hand finger extended from a rider's right hand when on the second hand-gripping portion of the handlebar. The first body portion is removably connected to the first hand-gripping portion of the handlebar, and the second body portion is removably connected to the second hand-gripping portion of the handlebar. The first and second body portions are ahead of the handlebar and are inline with respect to the first and second handled ends. In another embodiment, the first and second body portions are ahead of the handlebar between the first and second handled ends, are inline with respect to the first and second handled ends, and are down-angled relative to the handlebar.

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a first body portion opposing the first hand-gripping portion and a second body portion opposing the second hand-gripping portion, the first body portion is positioned and is shaped to receive so as to resist a leveraging force from left-hand fingers extended from a rider's left hand when on the first hand-gripping portion of the handlebar, and the second body portion is positioned and is shaped to receive so as to resist a leveraging force from right-hand fingers extended from a rider's right hand when on the second hand-gripping portion of the handlebar. The first body portion is removably connected to the first hand-gripping portion of the handlebar, and the second body portion is removably connected to the second hand-gripping portion of the handlebar. The first and second body portions are ahead of the handlebar and are inline with respect to the first and second handled ends. In another embodiment, the first and second body portions are ahead of the handlebar between the first and second handled ends, are inline with respect to the first and second handled ends, and are down-angled relative to the handlebar.

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion and a second body portion opposing the second hand-gripping portion, the first body portion is positioned and is shaped to receive so as to resist a leveraging force from a left-hand finger extended from a rider's left hand when on the first hand-gripping portion of the handlebar, and the second body portion is positioned and is shaped to receive so as to resist a leveraging force from a right-hand finger extended from a rider's right hand when on the second hand-gripping portion of the handlebar. The leveraging member is removably connected to the handlebar. The first and second body portions of the leveraging member are ahead of the handlebar and are inline with respect to the first and second handled ends, and the leveraging member is parallel relative to the handlebar. In another embodiment, the first and second body portions are ahead of the handlebar between the first and second handled ends, are inline with respect to the first and second handled ends, and are down-angled relative to the handlebar, and the leveraging member is parallel relative to the handlebar.

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion and a second body portion opposing the second hand-gripping portion, the first body portion is positioned and is shaped to receive so as to resist a leveraging force from left-hand fingers extended from a rider's left hand when on the first hand-gripping portion of the handlebar, and the second body portion is positioned and is shaped to receive so as to resist a leveraging force from right-hand fingers extended from a rider's right hand when on the second hand-gripping portion of the handlebar. The leveraging member is removably connected to the handlebar. The first and second body portions of the leveraging member are ahead of the handlebar and are inline with respect to the first and second handled ends, and the leveraging member is parallel relative to the handlebar. In another embodiment, the first and second body portions are ahead of the handlebar between the first and second handled ends, are inline with respect to the first and second handled ends, and are down-angled relative to the handlebar, and the leveraging member is parallel relative to the handlebar.

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion, a second body portion opposing the second hand-gripping portion, and a middle between the first and second body portions, the first body portion has a first finger-engaging stall positioned and shaped to receive so as to resist a leveraging force from a left-hand finger extended from a rider's left hand when on the first hand-gripping portion of the handlebar, and the second body portion has a second finger-engaging stall positioned and shaped to receive so as to resist a leveraging force from a right-hand finger extended from a rider's right hand when on the second hand-gripping portion of the handlebar. The leveraging member is removably connected to the handlebar. The first finger-engaging stall and the second finger-engaging stall are each in-turned toward the middle. The first and second body portions, including the first and second finger-engaging stalls, are ahead of the handlebar and are inline with respect to the first and second handled ends, and the leveraging member is parallel relative to the handlebar. In another embodiment, the first and second body portions, including the first and second finger-engaging stalls, are ahead of the handlebar, are inline with respect to the first and second handled ends, and are down-angled relative to the handlebar, and the leveraging member is parallel relative to the handlebar.

According to the principle of the invention, a handlebar assembly for a pedal-driven machine, especially a bicycle or a stationary bicycle or other like or similar stationary pedal-driven exercise machine, includes a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion, a second body portion opposing the second hand-gripping portion, and a middle between the first and second body portions, the first body portion has a first row of first finger-engaging stalls positioned and shaped to receive so as to resist leveraging forces from left-hand fingers extended from a rider's left hand when on the first hand-gripping portion of the handlebar, and the second body portion has a second row of second finger-engaging stalls positioned and shaped to receive so as to resist leveraging forces from right-hand fingers extended from a rider's right hand when on the second hand-gripping portion of the handlebar. The leveraging member is removably connected to the handlebar. The first finger-engaging stalls are in-turned toward the middle, the second finger-engaging stalls are in-turned toward the middle, and the first finger-engaging stalls are inline with respect to the second finger-engaging stalls. The first and second body portions, including the first finger-engaging stalls and the second finger-engaging stalls, are ahead of the handlebar and are inline with respect to the first and second handled ends, and the leveraging member is parallel relative to the handlebar. In another embodiment, the first and second body portions, including the first finger-engaging stalls and the second finger-engaging stalls, are ahead of the handlebar, are inline with respect to the first and second handled ends, and are down-angled relative to the handlebar, and the leveraging member is parallel relative to the handlebar.

### BRIEF DESCRIPTION OF THE DRAWINGS

Referring to the drawings:

FIG. 1 is a perspective view of a top side of a leverage assembly constructed and arranged in accordance with the principle of the invention, the leverage assembly useful in combination with a handlebar of a pedal-driven machine, especially a bicycle, for assisting a rider of the pedal-driven machine in achieving an improved mechanical advantage of the pedal-driven machine;

FIG. 2 is a perspective view of a bottom side of the embodiment of FIG. 1;

FIG. 3 is an exploded perspective view of the embodiment of FIG. 1;

FIG. 4 is an exploded perspective view of the embodiment of FIG. 2;

FIG. 5 is a top plan view of the embodiment of FIG. 1;

FIG. 6 is a bottom plan view of the embodiment of FIG. 1;

FIG. 7 is a section view taken along line 7-7 of FIG. 5;

FIG. 8 is a view of a rider depicted as he would appear riding a pedal-driven machine in the form of a bicycle in a typical crouched position, with his hands on a handlebar assembly constructed and arranged in accordance with the principle of the invention, the handlebar assembly including the leverage assembly of FIG. 1 and a handlebar;

FIG. 9 is an enlarged perspective view of the handlebar assembly of FIG. 9;

FIG. 10 is a front view of the embodiment of FIG. 9;

FIGS. 11-13 are views like that of FIG. 10 showing different gripping positions of the handlebar assembly;

FIG. 14 is a view similar to that of FIG. 8 illustrating the rider in a typical upright riding position with hands on the handlebar assembly and the leverage assembly positioned to relate to the upright riding position of the rider;

FIG. 15 is an enlarged perspective view of the handlebar assembly of FIG. 14; and

FIGS. 16-18 are enlarged front views of the embodiment of FIG. 15 showing different gripping positions of the handlebar assembly.

### DETAILED DESCRIPTION

Turning now to the drawings, in which like reference characters indicate corresponding elements throughout the several views, attention is drawn in relevant part to FIGS. 1-6, that together illustrate a leverage assembly 50 constructed and arranged in accordance with the principle of the invention and which is useful in combination with a handlebar of a pedal-driven machine, especially a bicycle or a stationary bicycle or other like or similar stationary pedal-driven exercise machine, for assisting a rider of the pedal-driven machine in achieving an improved mechanical advantage of the pedal-driven machine by improving the leverage between the cyclist and the bicycle to allow the rider of the pedal-driven machine to apply through the pumping action of his legs a greater pedaling force to the pedals of the pedal-driven machine via the rider concurrently gripping the handlebar and leveraging member 51 with his hands, and acting on leveraging assembly 50 with his fingers, such as by gripping leverage assembly 50 with his fingers, pushing laterally outward against leverage assembly 50 with his fingers in opposite directions, or both. Leverage assembly 50 includes leveraging member 51, and a connector assembly, consisting of band couplings 91 in the present embodiment, for removably connecting leveraging member 51 to the pedal-driven machine and, more particularly, to a handlebar of the pedal-driven machine so as to be useful in concert with the handlebar of the pedal-driven machine for the above purposes. The combination of a handlebar and leverage assembly 50 is a handlebar assembly.

Leveraging member 51 is fashioned of a plastic, a plastic composite, wood, carbon fiber a metal, such as aluminum or other metal or a metal composite, or other substantially rigid, lightweight, strong, rugged, resilient, and impact-resistant material or combination of materials. Leveraging member 51 is a unitary member that is preferably integrally formed, such as through machining or molding. In alternate embodiments, leveraging member 51 may be formed of a plurality of attached parts joined together with welding, adhesive, fasteners, joinery, etc.

Leveraging member 51 is elongate has opposed outer ends 52 and 53, intermediate portion or middle 54 equidistant between outer ends 52 and 53, rear and front ends, denoted generally at 55 and 56, respectively, and upper and lower ends, denoted generally at 57 and 58, respectively. Upper end 57 constitutes the top or top side of leveraging member 51, and lower end 58 constitutes the bottom or bottom side of leveraging member 51. Rear and front ends 55 and 56 and upper and lower ends 57 and 58 extend from outer end 52 to outer end 53. The length of leveraging member 51 is from outer end 52 to outer end 53.

Leveraging member 51 defines a body or body portion on either end of middle 54. One body or body portion 70A is defined from middle 54 to outer end 52, and the other body or body portion 70B is defined from middle 54 to outer end 53. Body portions 70A and 70B are the minor image of one another and are identical in every respect, both in structure and the resulting function when in use in concert with a handlebar of a pedal-driven machine, especially a bicycle or a stationary bicycle or other like or similar stationary pedal-driven exercise machine. For ease of discussion, each body or body portion 70A and 70B is now referred to simply as a body portion.

Body portion 70A extends from middle 54 to outer end, includes lug 80 formed in rear end 55, and finger-engaging portions 110, 111, and 112 formed in front end 56. Lug 80 along rear end 55 is between middle 54 and outer end 52 and is opposite to finger-engaging portions 110, 111, and 112 along front end 56 between middle 54 and outer end 52. Lug 80 is an extension of rear end 55, and extends rearwardly from rear end 55 to connecting end 81, which is adapted to be removably connected to band coupling 91A that, in turn, is adapted to be removably connected to a handlebar so as to removably connect body portion 70A to the handlebar.

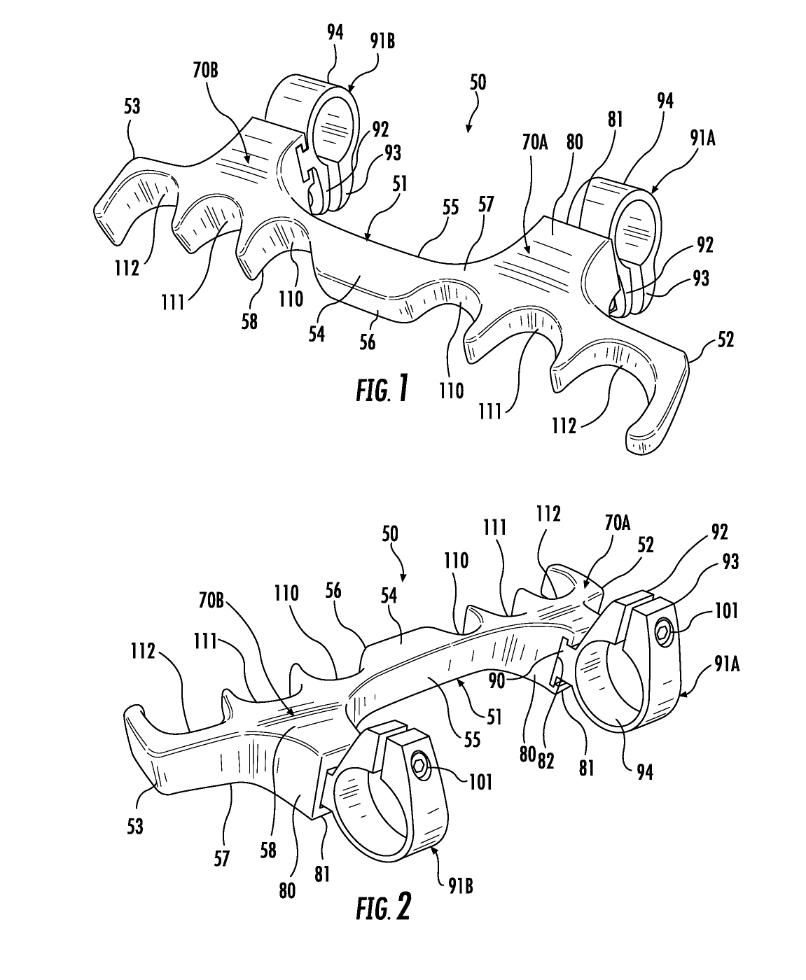

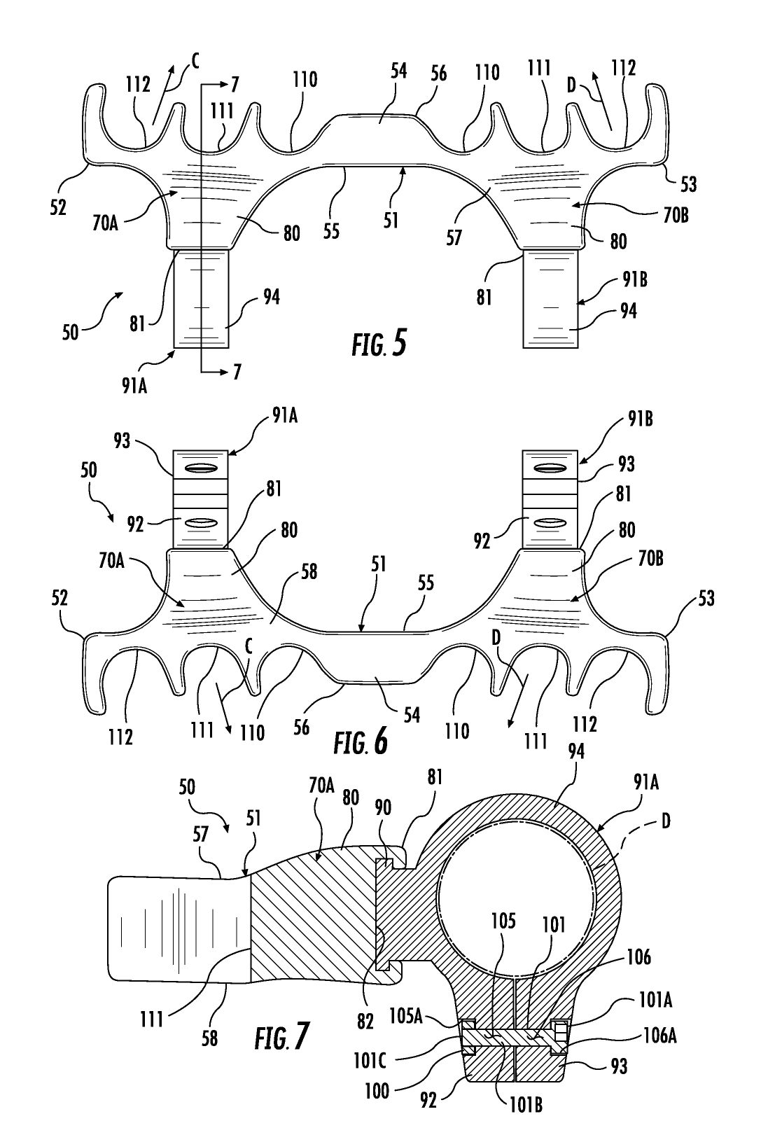

In FIGS. 2, 4, and 7, socket 82 in connecting end 81 of lug 80 accepts tongue 90 of band coupling 91A of leverage assembly 50 shown in FIGS. 2 and 7. Band coupling 91A is conventional and includes opposed connector ends 92 and 93 and circular bight 94 connecting connector ends 92 and 93. Tongue 90 of band coupling 91A and socket 82 in connecting end 81 of lug 80 correspond and constitute an engagement pair for removably connecting band coupling 91A to leveraging member 51 and, more specifically, for removably connecting band coupling 91A to connecting end 81 of lug 80 of body portion 70A of leveraging member 51. To removably connect socket 82 and tongue 90 in reference to FIG. 4, band coupling 91A is positioned upright from connector ends 92 and 93 to bight 94 between body portions 70A and 70B along rear end 55 of leveraging member 50 that is also positioned upright from lower end 58 to upper end 57 in concert with band connector 91A. Tongue 90 is aligned with the open inner end of socket 82, and band coupling 91A is simply moved in the direction of arrowed line A away from outer end 53 toward outer end 52 so as to slide and seat tongue 90 into socket 82. Once fully inserted or otherwise seated into socket 82, the closed upper, lower, and outer ends of socket 82 serve to hold tongue 90 in place. To disconnect or otherwise de-unite band coupling 91A from connecting end 81, the foregoing operation need only be reversed.

In this embodiment, socket 82 is an element of the engagement pair for removably connecting the connecting end 81 of lug 80 to band coupling 91A, and tongue 90 is the complemental element of such engagement pair. Socket 82 is exemplary of a female engagement element, and tongue 90 is exemplary of a male engagement element. Although socket 82 is carried by connecting end 81 of lug 80 of body portion 70A and tongue 90 is carried by band coupling 91A, this positioning is of no consequence and can be reversed in an alternate embodiment. The described tongue-and-socket engagement pair is exemplary, nevertheless, because it is easy to construct and simple to manipulate. In alternate embodiments, other selected engagement pairs can be used for removably connecting band coupling 91A to leveraging member 51 and, more specifically, to connecting end 81 of lug 80 of body portion 70A of leveraging member 51, such as a hook-and-loop engagement pair, a snap fastener engagement pair, a threaded engagement pair, a magnet engagement pair, etc.

Band coupling 91A is fashioned of a material having strong and flexible material characteristics, such as strong, flexible rubber or plastic, which allows band coupling 91A to yield so as to allow connector ends 92 and 93 to be spread apart a distance that is sufficient to allow an outer diameter of a length of a handlebar to be passed therethrough into bight 94 so as to be encircled by bight 94, all this for the purpose of removably connecting band coupling 91A to the subject handlebar. Connector ends 92 and 93 are secured and clamped together with a fastener in FIG. 7 to tighten and secure bight 94 against the outer diameter D of the subject handlebar passing therethrough so as to removably connect band coupling 91A to the handlebar. The sizes of the outer diameter of the handlebar and band coupling 91A are chosen so that they correspond to allow band coupling 91A to relate to the outer diameter of the handlebar in this way.

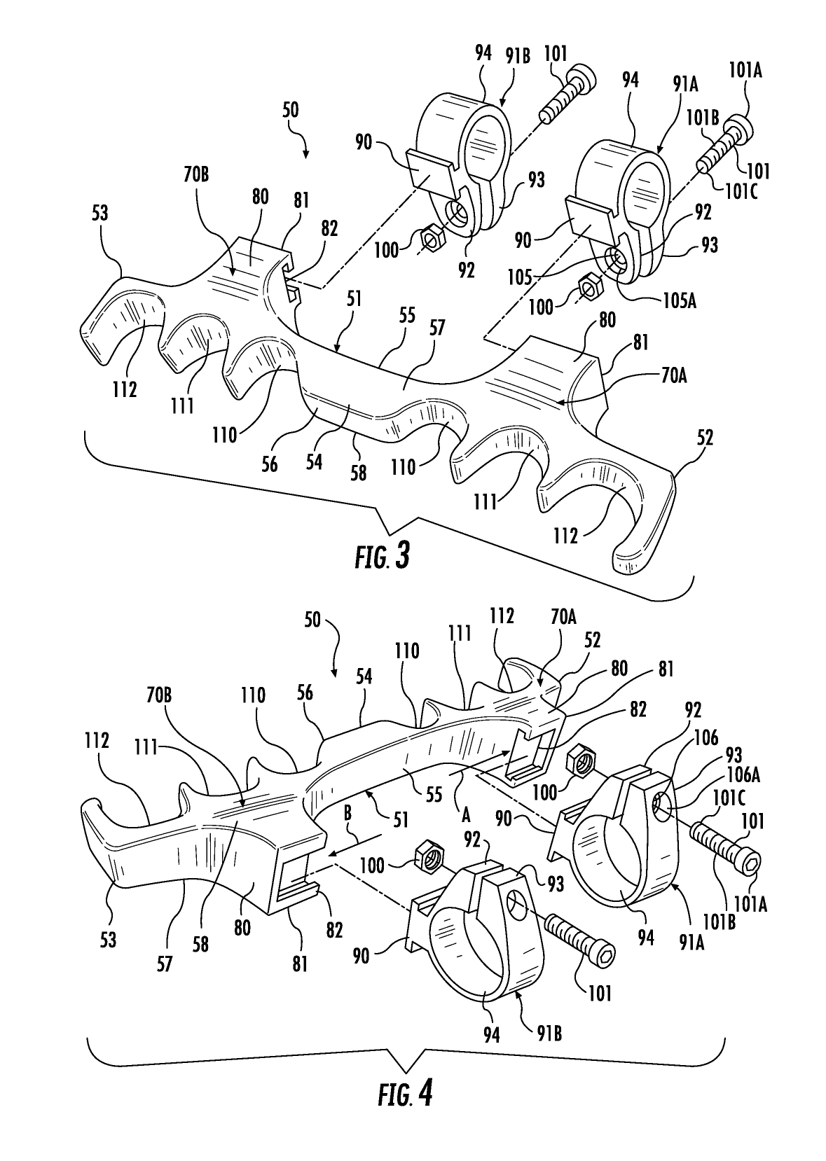

The fastener in FIG. 7 and also FIGS. 3 and 4 is a nut-and-bolt fastener consisting, naturally, of nut 100 and bolt 101. In FIG. 7, bolt 101 is inserted through aligned openings 105 and 106 through the corresponding connector ends 92 and 93. Head 101A of bolt 101 is sunk into counter bore 106A of opening 106 through connector end 93, and the shank 101B of bolt 101 extends first through opening 106 in connector end 93 and then through opening 105 in connector end 92 to its outer end 101C at counter bore 105A of opening 105 through connector end 92. Nut 100 is threaded onto outer end 101C via rotation, is sunk into counter bore 105A of opening 105, and is tightened via rotation to clamp connector ends 92 and 93 closer together between nut 100 and bolt 101 to, in turn, tighten and secure bight 94 against the outer diameter D of the length of handlebar passing therethrough. The foregoing operation need only be reversed to disconnect or otherwise de-unite band coupling 91A from the handlebar.

In FIGS. 1-6, finger-engaging portions 110, 111, and 112 are inline being arranged side-by-side in a row, and this row extends in a longitudinal direction along the length of leveraging member 51 in a direction from outer end 52 to outer end 53. Finger-engaging portion 111 is between, on the one hand, finger-engaging portion 110 near middle 54 and, on the other hand, finger-engaging portion 112 near outer end 52. Each finger-engaging portion 110, 111, and 112 is a finger-receiving stall that extends along the thickness of body portion 70A of leveraging member 51 from upper end 57 to lower end 58. The stalls defining finger-engaging portions 110, 111, and 112 are in-turned toward middle 54 in the direction of arrowed line C in FIGS. 5 and 6, and are each for receiving and interacting with a finger in the use of leverage assembly 50 in concert with a handlebar of a pedal-driven machine. Each stall is shaped to receive and interact with a finger. In this embodiment, each stall is a yoke consisting of a generally U-shaped component having a bight connecting opposed arms, as is clearly shown in FIGS. 1-6. In this example, finger engaging portions 110 and 11 share an arm, and finger engaging portions 111 and 112 share an arm, as is clearly shown in FIGS. 1-6.

Referencing FIGS. 1-6 in relevant part, body portion 70B extends from middle 54 to outer end 53. Body portion 70B is identical to body portion 70A, and the foregoing discussion of body portion 70A applies in every respect to body portion 70B. Briefly and identically to body portion 70A, body portion 70B shares lug 80, including connecting end 81 and socket 82, and finger-engaging portions 110, 111, and 112, which are inline being arranged side-by-side in a row that extends in a longitudinal direction along the length of leveraging member 51 in a direction from outer end 52 to outer end 53. The row of finger-engaging portions 110, 111, and 112 of body portion 70B is aligned with the row of finger-engaging portions 110, 111, and 112 of body portion 70A, in that the rows of finger-engaging portions 110, 111, and 112 of body portions 70A and 70B are arranged in a straight line. In other words, finger-engaging portions 110, 111, and 112 of body portion 70A are inline with respect to finger-engaging portions 110, 111, and 112 of body portion 70B.

Finger-engaging portion 111 is between, on the one hand, finger-engaging portion 110 near middle 54 and, on the other hand, finger-engaging portion 112 near outer end 53. Each finger-engaging portion 110, 111, and 112 is a stall that extends along the thickness of body portion 70A of leveraging member 51 from upper end 57 to lower end 58. The stalls defining finger-engaging portions 110, 111, and 112 are in-turned toward middle 54 in the direction of arrowed line D in FIGS. 5 and 6. In FIGS. 1-4, socket 82 in connecting end 81 of lug 80 accepts tongue 90 of band coupling 91B of leverage assembly 50. In common with band coupling 91A, band coupling 91B shares tongue 90, connector ends 92 and 93 and circular bight 94 connecting connector ends 92 and 93, and also the nut 100 and bolt 101 fastener in FIGS. 3 and 4 for securing and clamping connector ends 92 and 93. Band coupling 91B is removably connected to a handlebar and to body portion 70B in the same way that band coupling 91A is removably connected to a handlebar and to body portion 70A. Accordingly, the previous descriptions of band coupling 91A apply in every respect to band coupling 91B.

To removably connect socket 82 of body portion 70B and tongue 90 of band coupling 91B in reference to FIG. 4, band coupling 91B is positioned upright from connector ends 92 and 93 to bight 94 between body portions 70A and 70B along rear end 55 of leveraging member 50 that is also positioned upright from lower end 58 to upper end 57 in concert with band connector 91A. Tongue 90 is aligned with the open inner end of socket 82, and band coupling 91B is simply moved in the direction of arrowed line B away from outer end 53 toward outer end 52 so as to insert and seat tongue 90 into socket 82 of body portion 70B. Once fully inserted into socket 82 of band coupling 91B, the closed upper, lower, and outer ends of socket 82 serve to hold tongue 90 in place. To disconnect or otherwise de-unite band coupling 91B from connecting end 81 of body portion 70B, the foregoing operation need only be reversed.

It is to be emphasized that socket 82 of body portion 70B is an element of the engagement pair for removably connecting the connecting end 81 of body portion 70B to band coupling 91B, and tongue 90 of band coupling 91B is the complemental element of such engagement pair. In relation to this engagement pair, socket 82 is exemplary of a female engagement element, and tongue 90 is exemplary of a male engagement element. Although socket 82 is carried by connecting end 81 of lug 80 of body portion 70B and tongue 90 is carried by band coupling 91B, this positioning is of no consequence and can be reversed in an alternate embodiment. The described tongue-and-socket engagement pair is exemplary because it is easy to construct and simple to manipulate. In alternate embodiments, other selected engagement pairs can be used for removably connecting band coupling 91B to leveraging member 51 and, more specifically, to connecting end 81 of lug 80 of body portion 70B of leveraging member 51, such as a hook-and-loop engagement pair, a snap fastener engagement pair, a threaded engagement pair, a magnet engagement pair, etc.

Leverage assembly 50 useful in combination with a pedal-driven machine, such as a bicycle or a stationary bicycle or other like or similar stationary pedal-driven exercise machine. In FIG. 8 leveraging assembly 50 is shown in combination with bicycle 120 in FIG. 8 for assisting a rider 121 of bicycle 120 in applying a greater pedaling force to the pedals of bicycle 120 via his legs so as to achieve a greater mechanical advantage of bicycle 120 in driving pedals of bicycle 120 with his legs. Briefly, bicycle 120 includes frame 130 having a front or forward end denoted generally at 131, and an opposed rear or rearward end denoted generally at 132. Frame 130 consists of top tube 140 and an opposed down tube 141 that extend between front 131 and rear 132. Top and bottom tubes 140 and 141 are connected at front 131 with a head tube 142, and are connected at rear 132 with an upright seat tube 143. Opposed seat stays 144 (only one shown) are connected to seat tube 143 at rear 132 of frame 130, and opposed chain stays 145 (only one shown) are connected to bottom tube 141 and seat tube 143 at rear 132 of frame 130. Seat stays 144 extend downwardly and rearwardly from seat tube 143, chain stays 145 extend rearwardly of bottom tube 141 and seat tube 143, and seat stays 144 and chain stays 145 meet and connect and are coupled to a rear hub of rear wheel 146.

Handlebar 160 is connected to head tube 142 with headset 153 that is connected to the upper end of a fork stem (not shown) that extends downwardly through head tube 142 to front forks 147, which extend downwardly and connect a front hub of front wheel 148. Front wheel 148 is positioned in front of rear wheel 146, which is in-line with respect to front wheel 148. Seat 150 is mounted to seat post 151 that extends into and is rigidly connected to seat tube 143. Bicycle 120 is pedal-driven and is thus exemplary of a non-motorized pedal-driven machine, and includes a pedal-driven drive train consisting of pedals 155 (only one shown) attached to crank arms 156 (only one shown) rigidly connected to a bottom bracket 157 that is, in turn, rigidly connected to a chain ring (not shown). An endless chain (not shown) concurrently encircles and operatively couples the chain ring to a cassette (not shown) formed in the rear of rear wheel 146 to impart rotation to rear wheel 146 in response to rotation of the chain ring made through a pedaling action applied to pedals 155 by rider 121 seated on seat 150. The drive train of bicycle 120 is a conventional form of a pedaled drive train commonly found among conventional bicycles.

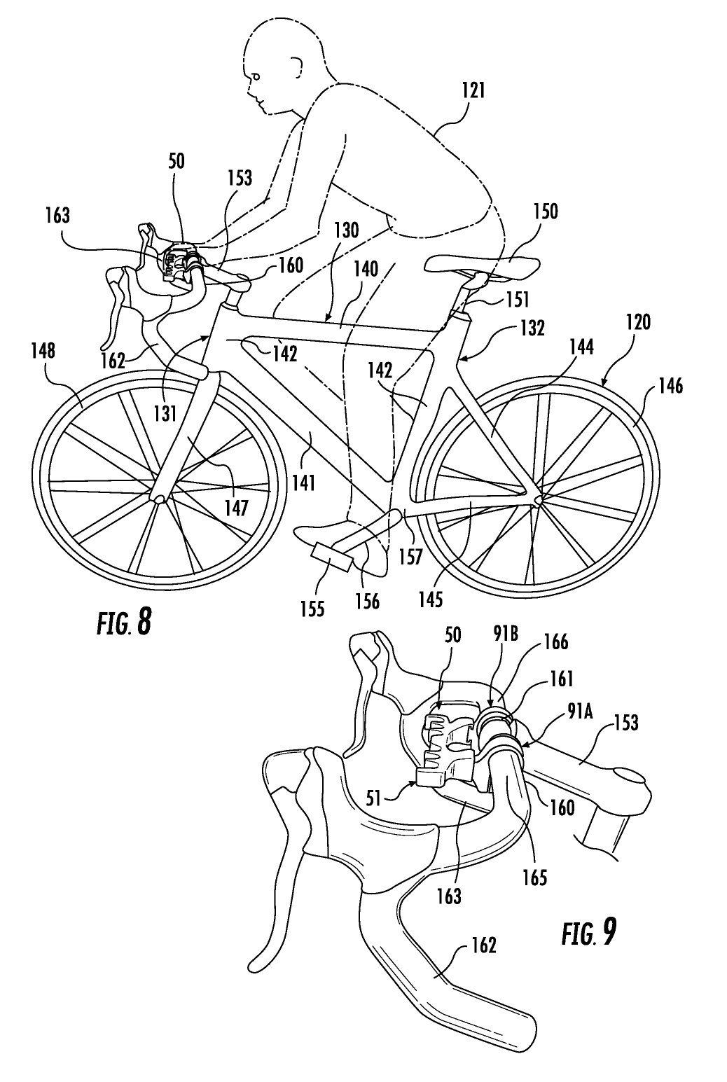

In FIGS. 9 and 10, elongate, generally horizontal handlebar 160 includes intermediate portion 161 mounted to headset 153, opposed, forwardly-extending handled ends 162 and 163, hand-gripping portion 165 on handlebar 160 between intermediate portion 161 and handled end 162, and opposite hand-gripping portion 166 on handlebar 160 between intermediate portion 161 and handled end 163. In the normal use of bicycle 120, the rider may grip handled ends 162 and 163 or, such as when in a climbing mode for riding bicycle 120 up an incline or in a time-trial position or simply as he so wishes, may grip hand-gripping portions 165 and 166 on either side of intermediate portion 161 and head set 153 attached to intermediate portion 161.

Bicycle 120 is exemplary of a non-motorized, two-wheeled, pedal-driven vehicle, is entirely conventional and is generally representative of any one of a variety of commercially available bicycles. Accordingly, further details of bicycle not herein specifically disclosed will readily occur to those having ordinary skill and are not discussed in further detail.

In FIGS. 8-10, leverage assembly 50 is removably connected to handlebar 160 between handled ends 162 and 163 so as to form a handlebar assembly constructed and arranged in accordance with the principle of the invention. In FIGS. 9 and 10, leveraging member 51 is removably connected to handlebar 160 of bicycle 120 via band couplings 91A and 91B. Specifically, band coupling 91A is removably connected to hand-gripping portion 165 of handlebar 160 between intermediate portion 161 and handled end 162, band coupling 91B is removably connected to hand-gripping portion 166 of handlebar 160 between intermediate portion 161 of handled end 162, and leveraging member 51 is, in turn, removably connected to band couplings 91A and 91B. The way in which band couplings 91A and 91B are connected to handlebar 160 is as discussed above, and thus is not described again as to do so would be unnecessarily repetitive. With this arrangement, body portion 70A is removably connected to hand-gripping portion 165 of handlebar 160 via band connector 91A, and body portion 70B is removably connected to hand-gripping portion 166 of handlebar 160 via band connector 91B.

In the attachment of leverage assembly 50 to handlebar 160, leveraging member 51 is positioned ahead of handlebar 160 between handled ends 162 and 163, is horizontal to relate to the crouched riding position of rider 121, is parallel relative to handlebar 160 between handled ends 162 and 163 and extends from outer end 52 directed toward handled end 162 on one side of intermediate portion 161 to outer end 53 directed toward handled end 163 on the opposite side of intermediate portion 161, is equidistant relative to handled ends 162 and 163, and is inline with respect to handled ends 162 and 163. Leveraging member 51 extends outward from connector ends 81 of rear end 55 of leveraging member 51 removably connected to band couplings 91A and 91B, to front end 56 and, moreover, to the stalls in front end 56 that define finger-engaging portions 110, 111, and 112 of body portion 70A, and to the stalls in front end 56 that define finger-engaging portions 110, 111, and 112 of body portion 70B. With this arrangement, body portion 70A is positioned ahead of hand-gripping portion 165 of handlebar 160 between intermediate portion 161 and handled end 162, body portion 70B is positioned ahead of hand-gripping portion 166 of handlebar 160 between intermediate portion 161 and handled end 163, and body portions 70A and 70B are inline with respect to each other and are inline with respect to handled ends 162 and 163. Body portion 70A extends outward from connector end 81 thereof of rear end 55 of leveraging member 51 removably connected to band coupling 91A to front end 56 of body portion 70A and to the stalls in front end 56 that define finger-engaging portions 110, 111, and 112 of body portion 70A. Body portion 70B, in turn, extends outward from connector end 81 thereof of rear end 55 of leveraging member 51 removably connected to band coupling 91B to front end 56 of body portion 70B and to the stalls in front end 56 that define finger-engaging portions 110, 111, and 112 of body portion 70B. The stalls in front end 56 that define finger-engaging portions 110, 111, and 112 of body portion 70A are inline with respect to the stalls in front end 56 that define finger-engaging portions 110, 111, and 112 of body portion 70B, and the stalls that define finger-engaging portions 110, 111, and 112 of body portions 70A and 70B are inline with respect to handled ends 162 and 163.

The row of stalls in front end 56 that define finger-engaging portions 110, 111, and 112 of body portion 70A are ahead of and parallel relative to handlebar 160 between handled ends 162 and 163 and, more specifically, are ahead of and parallel relative to hand-gripping portion 165 of handlebar 160 between intermediate portion 161 and handled end 162. The row of stalls in front end 56 that define finger-engaging portions 110, 111, and 112 of body portion 70B are ahead of and parallel relative to handlebar 160 between handled ends 162 and 163 and, more specifically, are ahead of and parallel relative to hand-gripping portion 166 of handlebar 160 between intermediate portion 161 and handled end 163. As row of finger-engaging portions 110, 111, and 112 of body portion 70B is aligned with the row of finger-engaging portions 110, 111, and 112 of body portion 70A, the rows of finger-engaging portions 110, 111, and 112 of body portions 70A and 70B are arranged in a straight line that is parallel with respect to handlebar 160 extending between handled ends 162 and 163.

As rider 121 rides bicycle 120 in the crouched position as in FIG. 8, he generally sits in a crouched position with his feet on the pedals 155 and his left and right hands 180 and 181 on hand-gripping portions 165 and 166 as shown in FIG. 10. This position is common when climbing, i.e. riding bicycle 120 up an incline, or when time trialing. Leverage assembly 50 is useful in concert with handlebar 160 of for assisting rider 121 of bicycle 120 in applying a greater pedaling force to pedals 155 through the pumping action of his legs via the rider concurrently gripping hand-gripping portions 165 and 166 of handlebar 160 and leveraging member 51 with his left and right hands 180 and 181 so as to achieve a greater mechanical advantage of bicycle 120 via the application of one or more leveraging forces applied to leveraging member 51 via one or more of the rider's left hand fingers and one or more of the rider's right hand fingers. Leveraging member 51 is positioned in juxtaposition with respect to, or otherwise in such proximity to, hand-gripping portions 165 and 166 of handlebar 160 such that a rider can concurrently grip hand-gripping portion 165 of handlebar 160 and body portion 70A of leveraging member 51 with his left hand, and such that the rider can likewise concurrently grip hand-gripping portion 166 of handlebar 160 and body portion 70B of leveraging member 51 with his right hand, all for the purpose of achieving a greater mechanical advantage of bicycle 120. This is discussed in detail below.

Specifically, with left and right hands 180 and 181 on and gripping hand-gripping parts 165 and 166, respectively, the index, middle, and ring fingers of left hand 180 are extended outwardly from hand-gripping portion 165 of handlebar 160 over body portion 70A and into the corresponding stalls that define the corresponding finger-engaging portions 110, 111, and 112, respectively, of body portion 70A, and the index, middle, and ring fingers of right hand 181 are extended outwardly from hand-gripping portion 166 of handlebar 160 over body portion 70B and into the corresponding stalls that define the corresponding finger-engaging portions 110, 111, and 112, respectively, of body portion 70B. As the row of stalls in front end 56 that define finger-engaging portions 110, 111, and 112 of body portion 70A is parallel relative to hand-gripping portion 165 of handlebar 160 between intermediate portion 161 and handled end 162, it is a simple matter for the rider to extend his left-hand fingers outwardly, so as to be nearly straight, and over body portion 70A to finger-engaging portions 110, 111, and 112 of body portion 70A Likewise, as the row of stalls in front end 56 that define finger-engaging portions 110, 111, and 112 of body portion 70B is parallel relative to hand-gripping portion 166 of handlebar 160 between intermediate portion 161 and handled end 163 and also aligned with the row of stalls in front end 56 that define finger-engaging portions 110, 111, and 112 of body portion 70A, it is a simple matter for the rider to extend his right-hand fingers outwardly, so as to be nearly straight, and over body portion 70B to finger-engaging portions 110, 111, and 112 of body portion 70B.

The stalls that define the finger-engaging portions 110, 111, and 112 of body portion 70A receive and interact with said left-hand fingers applied therein so as to resist leveraging forces applied thereto from said left-hand fingers extended from the rider's left hand when on hand-gripping portion 165 of handlebar 160, including a gripping force in a rearward direction toward the handlebar 160 from said left-hand fingers extended from the rider's left hand when on hand-gripping portion 165 of handlebar 160, a lateral force in the direction of arrowed line E toward handled end 162 from said left-hand fingers extended from the rider's left hand when on hand-gripping portion 165 of handlebar 160, or both the gripping and lateral forces. Further, the stalls that define the finger-engaging portions 110, 111, and 112 of body portion 70B receive and interact with said right-hand fingers applied therein so as to resist leveraging forces applied thereto from said right-hand fingers extended from the rider's right hand when on hand-gripping portion 165 of handlebar 160, including a gripping force in a rearward direction toward handlebar 160 from said right-hand fingers extended from the rider's right hand when on hand-gripping portion 165 of handlebar 160, a lateral force in the direction of arrowed line E toward handled end 162 from said right-hand fingers extended from the rider's right hand when on hand-gripping portion 165 of handlebar 160, or both the gripping and lateral forces. By so doing and quite surprisingly, additional or improved leverage is obtained for applying a greater pedaling force to pedals 155 in response to the rider concurrently gripping handlebar 160 and body portions 70A and 70B as described and applying one or both of the described leveraging forces against body portions 70A and 70B via his left-hand and right-hand fingers extended from the respective hand-gripping portions 165 and 166 of handlebar 160 to the respective body portions 70A and 70B while the remainder of the rider's left and right hands remain on the corresponding left-and right- hand gripping portions 165 and 166. In other words, this assists rider 121 of bicycle 120 in achieving the surprising result of an improved mechanical advantage of bicycle 120 by improving the leverage between rider 121 and bicycle 120 to allow rider 120 of bicycle 120 to apply a greater pedaling force to pedals 155 of bicycle 120 via rider 121 concurrently gripping handlebar 160 and body portions 70A and 70B with his hands and applying one or more of the described leveraging forces against the respective body portions 70A and 70B of leverage assembly 50 with his extended fingers.

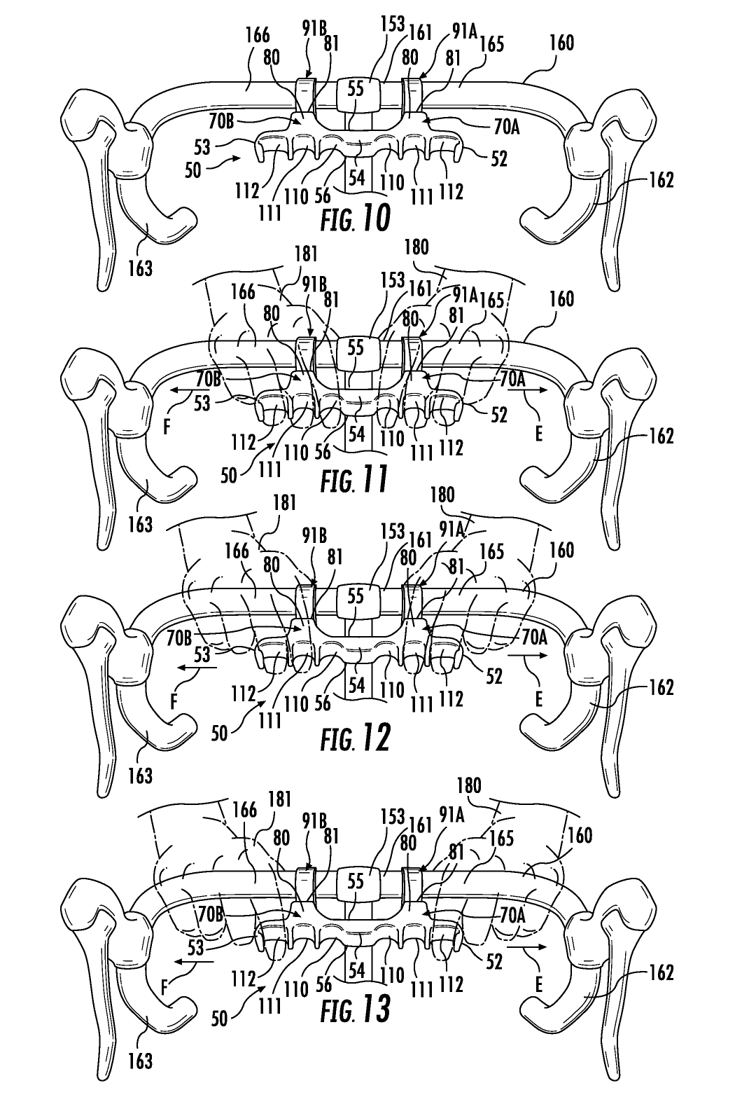

FIG. 11 shows each of the finger-engaging portions 110, 111, and 112 of body portions 70A and 70B occupied by a finger. Less than all of finger-engaging portions 110, 111, and 112 can be selected to be used in the manner discussed above depending on the positioning of the rider while obtaining the same surprising and beneficial result, namely, an improved mechanical advantage of bicycle 120. As a matter of example, in FIG. 12 with left and right hands 180 and 181 on and gripping hand-gripping parts 165 and 166, respectively, the index and middle fingers of left hand 180 are extended outwardly from hand-gripping portion 165 of handlebar 160 over body portion 70A and into the corresponding stalls that define the corresponding finger-engaging portions 111 and 112, respectively, of body portion 70A, and the index and middle fingers of right hand 181 are extended outwardly from hand-gripping portion 166 of handlebar 160 over body portion 70B and into the corresponding stalls that define the corresponding finger-engaging portions 111 and 112, respectively, of body portion 70B. In this example, the improved mechanical advantage of bicycle 120 is obtained in response to the rider applying one or more of the described leveraging forces against the stalls that define the finger-engaging portions 111 and 112 of body portion 70A with his left hand fingers while the remainder of left hand 180 concurrently grips hand-gripping portion 165 of handlebar 160, and applying one or more of the described leveraging forces against the stalls that define the finger-engaging portions 111 and 112 of body portion 70B with his right hand fingers while the remainder of the right hand concurrently grips hand-gripping portion 166 of handlebar 160.

In another example, in FIG. 13 with left and right hands 180 and 181 on and gripping hand-gripping parts 165 and 166, respectively, the index finger of left hand 180 is extended outwardly from hand-gripping portion 165 of handlebar 160 over body portion 70A and into the corresponding stall that defines finger-engaging portion 112 of body portion 70A, and the index finger of right hand 181 is extended outwardly from hand-gripping portion 166 of handlebar 160 over body portion 70B and into the stall that defines finger-engaging portion 112 of body portion 70B. In this example, the improved mechanical advantage of bicycle 120 is obtained in response to the rider applying one or more of the described leveraging forces against the stall that defines the finger-engaging portion 112 of body portion 70A with his left hand index finger while the remainder of left hand 180 concurrently grips hand-gripping portion 165 of handlebar 160 and, and applying one or more of the described leveraging forces against the stall that defines the finger-engaging portion 112 of body portion 70B with his right hand index finger while the remainder of right hand 181 concurrently grips hand-gripping portion 166 of handlebar 160.

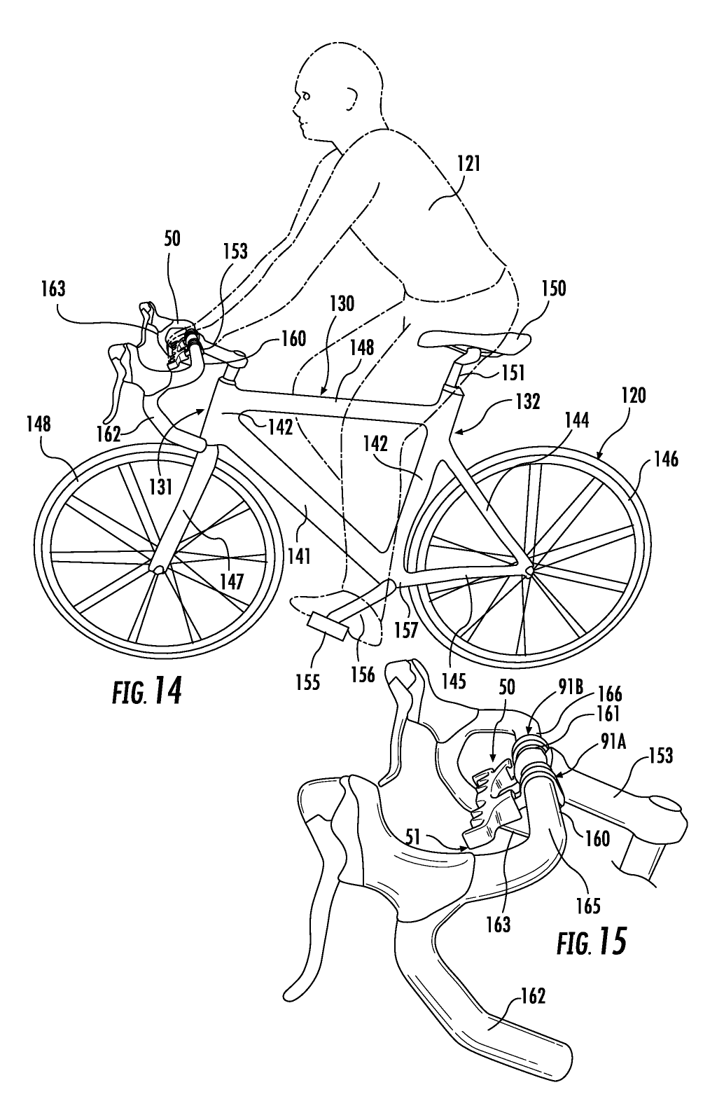

Depending on the comfort of the rider, one or more fingers of the rider's left and right hands can be extend into any one or more of the stalls defining the finger-engaging portions 110, 111, and 112 of body portions 70A and 70B, respectively, in the use of leverage assembly 50 with handlebar 160 in assisting a rider of bicycle 120 in achieving the greater mechanical advantage of bicycle 120 as herein specifically described, and this also applies to the discussion of the handlebar assembly in conjunction with FIGS. 14-18.

In FIGS. 8-13, leveraging member 51 is positioned ahead of handlebar 160 between handled ends 162 and 163 and horizontal to relate to the crouched riding position of rider 121. FIGS. 14 and 15 are views similar to that of FIGS. 8 and 9, respectively, illustrating leveraging member 51 positioned ahead of handlebar 160 between handled ends 162 and 163, and down-angled relative to handlebar 160 to relate to an upright riding position of rider 121 in FIG. 14. Leverage assembly 50 is secured to handlebar 160 in this down-angled orientation to relate to rider 121 in the upright riding position as shown. Apart from this difference, the previous discussion of the handlebar assembly consisting of the combination of handlebar 160 and leverage assembly 50 applies in every respect to the configuration of the handlebar assembly depicted in FIGS. 14 and 15. Nevertheless, the use of the handlebar assembly in the down-angled orientation of leveraging member 51 of leverage assembly 50 is discussed briefly below.

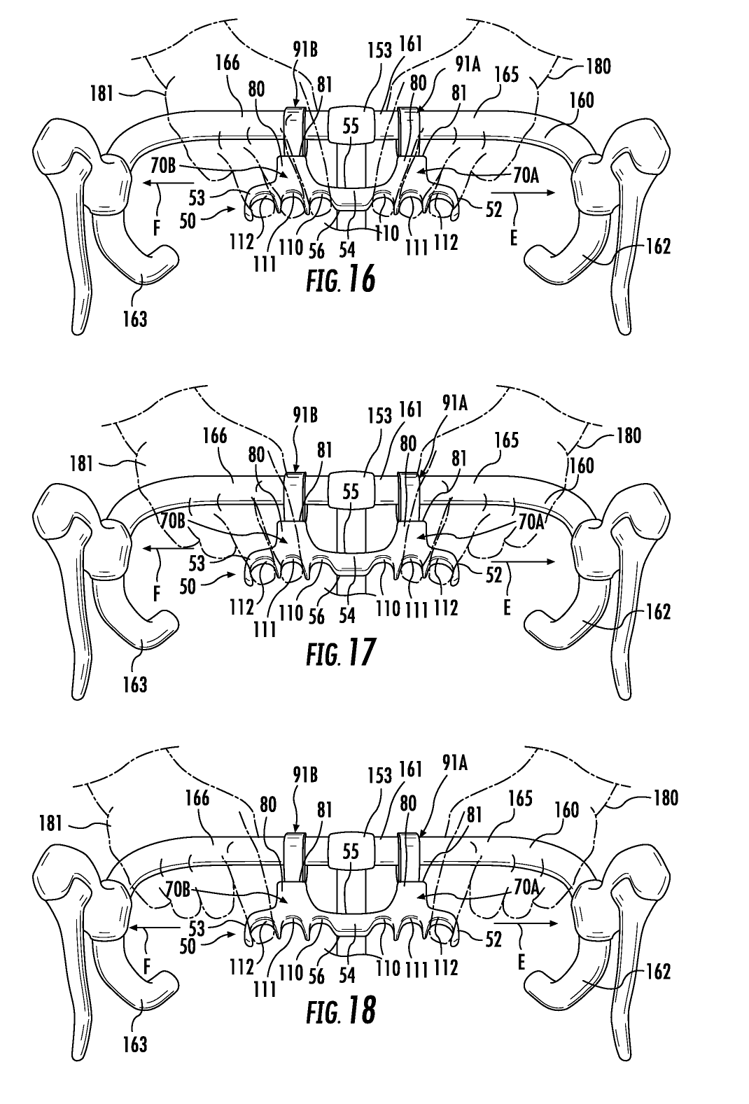

In FIGS. 15 and 16, leveraging member 51 is positioned ahead of handlebar 160 between handled ends 162 and 163, is inline with respect to handled ends 162 and 163, is down-angled to relate to the upright riding position of rider 121, and is parallel relative to handlebar 160 between handled ends 162 and 163 and extends from outer end 52 directed toward handled end 162 on one side of intermediate portion 161 to outer end 53 directed toward handled end 163 on the opposite side of intermediate portion 161, and is equidistant relative to handled ends 162 and 163. Leveraging member 51 extends outward and downward from connector ends 81 of rear end 55 of leveraging member 51 removably connected to band couplings 91A and 91B, to front end 56 and, moreover, to the stalls in front end 56 that define finger-engaging portions 110, 111, and 112 of body portion 70A, and to the stalls in front end 56 that define finger-engaging portions 110, 111, and 112 of body portion 70B. With this arrangement, body portion 70A is positioned ahead of hand-gripping portion 165 of handlebar 160 between intermediate portion 161 and handled end 162 and is down-angled relative to hand-gripping portion 165 of handlebar 160, body portion 70B is positioned ahead of hand-gripping portion 166 of handlebar 160 between intermediate portion 161 and handled end 163 and is down-angled relative to hand-gripping portion 166 of handlebar 160, and body portions 70A and 70B are inline with respect to each other and are inline with respect to handled ends 162 and 163. Body portion 70A extends outward and downward from connector end 81 thereof of rear end 55 of leveraging member 51 removably connected to band coupling 91A to front end 56 of body portion 70A and to the stalls in front end 56 that define finger-engaging portions 110, 111, and 112 of body portion 70A. Body portion 70B, in turn, extends outward and downward from connector end 81 thereof of rear end 55 of leveraging member 51 removably connected to band coupling 91B to front end 56 of body portion 70B and to the stalls in front end 56 that define finger-engaging portions 110, 111, and 112 of body portion 70B. The stalls in front end 56 that define finger-engaging portions 110, 111, and 112 of body portion 70A are inline with respect to the stalls in front end 56 that define finger-engaging portions 110, 111, and 112 of body portion 70B, and the stalls that define finger-engaging portions 110, 111, and 112 of body portions 70A and 70B are inline with respect to handled ends 162 and 163.

The row of stalls in front end 56 that define finger-engaging portions 110, 111, and 112 of body portion 70A are ahead of and down-angled and parallel relative to handlebar 160 between handled ends 162 and 163 and, more specifically, are ahead of and down-angled and parallel relative to hand-gripping portion 165 of handlebar 160 between intermediate portion 161 and handled end 162. The row of stalls in front end 56 that define finger-engaging portions 110, 111, and 112 of body portion 70B are ahead of and down-angled and parallel relative to handlebar 160 between handled ends 162 and 163 and, more specifically, are ahead of and down-angled and parallel relative to hand-gripping portion 166 of handlebar 160 between intermediate portion 161 and handled end 163. As row of finger-engaging portions 110, 111, and 112 of body portion 70B is aligned with the row of finger-engaging portions 110, 111, and 112 of body portion 70A, the rows of finger-engaging portions 110, 111, and 112 of body portions 70A and 70B are arranged in a straight line that is parallel with respect to handlebar 160 extending between handled ends 162 and 163 in this down-angled configuration of leverage assembly 50.

As rider 121 rides bicycle 120 in the upright position as in FIG. 14, he generally sits in an upright position with his feet on the pedals 155 and his left and right hands 180 and 181 on hand-gripping portions 165 and 166 as shown in FIG. 10. This position is common when cruising, i.e. riding bicycle 120 along a horizontal surface. Again, leverage assembly 50 is useful in concert with handlebar 160 of for assisting rider 121 of bicycle 120 in applying a greater pedaling force to pedals 155 through the pumping action of his legs via the rider concurrently gripping hand-gripping portions 165 and 166 of handlebar 160 and leveraging member 51 with his left and right hands 180 and 181 so as to achieve a greater mechanical advantage of bicycle 120.

Specifically, with left and right hands 180 and 181 on and gripping hand-gripping parts 165 and 166, respectively, the index, middle, and ring fingers of left hand 180 are extended outwardly and downwardly from hand-gripping portion 165 of handlebar 160 over body portion 70A and into the corresponding stalls that define the corresponding finger-engaging portions 110, 111, and 112, respectively, of body portion 70A, and the index, middle, and ring fingers of right hand 181 are extended outwardly and downwardly from hand-gripping portion 166 of handlebar 160 over body portion 70B and into the corresponding stalls that define the corresponding finger-engaging portions 110, 111, and 112, respectively, of body portion 70B. As the row of stalls in front end 56 that define finger-engaging portions 110, 111, and 112 of body portion 70A is parallel relative to hand-gripping portion 165 of handlebar 160 between intermediate portion 161 and handled end 162, it is a simple matter for the rider to extend his left-hand fingers outwardly and downwardly, so as to be nearly straight, and over body portion 70A to finger-engaging portions 110, 111, and 112 of body portion 70A Likewise, as the row of stalls in front end 56 that define finger-engaging portions 110, 111, and 112 of body portion 70B is parallel relative to hand-gripping portion 166 of handlebar 160 between intermediate portion 161 and handled end 163 and also aligned with the row of stalls in front end 56 that define finger-engaging portions 110, 111, and 112 of body portion 70A, it is a simple matter for the rider to extend his right-hand fingers outwardly and downwardly, so as to be nearly straight, and over body portion 70B to finger-engaging portions 110, 111, and 112 of body portion 70B.

In FIG. 16, the stalls that define the finger-engaging portions 110, 111, and 112 of body portion 70A receive and interact with said left-hand fingers applied therein so as to resist leveraging forces applied thereto from said left-hand fingers extended from the rider's left hand when on hand-gripping portion 165 of handlebar 160, including a gripping force in a rearward direction toward handlebar 160 from said left-hand fingers extended outwardly and downwardly from the rider's left hand when on hand-gripping portion 165 of handlebar 160, a lateral force in the direction of arrowed line E toward handled end 162 from said left-hand fingers extended outwardly and downwardly from the rider's left hand when on hand-gripping portion 165 of handlebar 160, or both the gripping and lateral forces. Further, the stalls that define the finger-engaging portions 110, 111, and 112 of body portion 70B receive and interact with said right-hand fingers applied therein so as to resist leveraging forces applied thereto from said right-hand fingers extended outwardly and downwardly from the rider's right hand when on hand-gripping portion 165 of handlebar 160, including a gripping force in a rearward direction toward handlebar 160 from said right-hand fingers extended outwardly and downwardly from the rider's right hand when on hand-gripping portion 165 of handlebar 160, a lateral force in the direction of arrowed line E toward handled end 162 from said right-hand fingers extended outwardly and downwardly from the rider's right hand when on hand-gripping portion 165 of handlebar 160, or both the gripping and lateral forces. By so doing and again quite surprisingly, additional or improved leverage is obtained for applying a greater pedaling force to pedals 155 in response to the rider concurrently gripping handlebar 160 and body portions 70A and 70B as described and applying one or both of the described leveraging forces against body portions 70A and 70B via his left-hand and right-hand fingers extended from the respective hand-gripping portions 165 and 166 of handlebar 160 to the respective body portions 70A and 70B while the remainder of the rider's left and right hands remain on the corresponding left- and right-hand gripping portions 165 and 166. In other words, this assists rider 121 of bicycle 120 in achieving the surprising result of an improved mechanical advantage of bicycle 120 by improving the leverage between rider 121 and bicycle 120 to allow rider 120 of bicycle 120 to apply a greater pedaling force to pedals 155 of bicycle 120 via rider 121 concurrently gripping handlebar 160 and body portions 70A and 70B with his hands and applying one or more of the described leveraging forces against the respective body portions 70A and 70B of leverage assembly 50 with his extended fingers.

FIG. 16 shows each of the finger-engaging portions 110, 111, and 112 of body portions 70A and 70B occupied by a finger. Less than all of finger-engaging portions 110, 111, and 112 can be selected to be used in the manner discussed above in the down-angled configuration of leverage assembly 50 depending on the positioning of the rider while obtaining the same surprising and beneficial result, namely, an improved mechanical advantage of bicycle 120. As a matter of example, in FIG. 17 with left and right hands 180 and 181 on and gripping hand-gripping parts 165 and 166, respectively, the index and middle fingers of left hand 180 are extended outwardly and downwardly from hand-gripping portion 165 of handlebar 160 over body portion 70A and into the corresponding stalls that define the corresponding finger-engaging portions 111 and 112, respectively, of body portion 70A, and the index and middle fingers of right hand 181 are extended outwardly and downwardly from hand-gripping portion 166 of handlebar 160 over body portion 70B and into the corresponding stalls that define the corresponding finger-engaging portions 111 and 112, respectively, of body portion 70B. In this example, the improved mechanical advantage of bicycle 120 is obtained in response to the rider applying one or more of the described leveraging forces against the stalls that define the finger-engaging portions 111 and 112 of body portion 70A with his left hand fingers while the remainder of left hand 180 concurrently grips hand-gripping portion 165 of handlebar 160, and applying one or more of the described leveraging forces against the stalls that define the finger-engaging portions 111 and 112 of body portion 70B with his right hand fingers while the remainder of the right hand concurrently grips hand-gripping portion 166 of handlebar 160.

In another example in the down-angled configuration of leverage assembly 50, in FIG. 18 with left and right hands 180 and 181 on and gripping hand-gripping parts 165 and 166, respectively, the index finger of left hand 180 is extended outwardly and downwardly from hand-gripping portion 165 of handlebar 160 over body portion 70A and into the corresponding stall that defines finger-engaging portion 112 of body portion 70A, and the index finger of right hand 181 is extended outwardly and downwardly from hand-gripping portion 166 of handlebar 160 over body portion 70B and into the stall that defines finger-engaging portion 112 of body portion 70B. In this example, the improved mechanical advantage of bicycle 120 is obtained in response to the rider applying one or more of the described leveraging forces against the stall that defines the finger-engaging portion 112 of body portion 70A with his left hand index finger while the remainder of left hand 180 concurrently grips hand-gripping portion 165 of handlebar 160 and, and applying one or more of the described leveraging forces against the stall that defines the finger-engaging portion 112 of body portion 70B with his right hand index finger while the remainder of right hand 181 concurrently grips hand-gripping portion 166 of handlebar 160.

Again, depending on the comfort of the rider, in the down-angled configuration of leveraging assembly 50 one or more fingers of the rider's left and right hands can be extend into any one or more of the stalls defining the finger-engaging portions 110, 111, and 112 of body portions 70A and 70B, respectively, in the use of leverage assembly 50 with handlebar 160 in assisting a rider of bicycle 120 in achieving the greater mechanical advantage of bicycle 120 as herein specifically described.

To recount, FIGS. 8-13 show leveraging member 51 positioned horizontally and ahead of handlebar 160 between handled ends 162 and 163 and horizontal to relate to the crouched riding position of rider 121 to assist rider 121 in achieving the greater mechanical advantage of bicycle 120, while FIGS. 14-18 show leveraging member 51 positioned ahead of handlebar 160 between handled ends 162 and 163, and down-angled relative to handlebar 160 to relate to an upright riding position of rider 121 to assist rider 121 in achieving the greater mechanical advantage of bicycle 120. And so leveraging member 51 can be set to different positions as preselected by a rider of a bicycle to relate to the preselected riding position of the rider, including the horizontal position of leveraging member 51 as in FIGS. 8-13, the down-angled position of leveraging member 51 as in FIGS. 14-18, and at any position therebetween as may be preferred by the rider.

The invention has been described above with reference to preferred embodiments. However, those skilled in the art will recognize that changes and modifications may be made to the embodiments without departing from the nature and scope of the invention. For instance, leveraging member 51 is removably connected to handlebar 160 in a preferred embodiment, which allows leveraging member 51 to be attached to any handlebar and removed and re-attached as needed, such as for cleaning, repair, or replacement. In an alternate embodiment, leveraging member 51 may be formed integrally with handlebar 160 so as to be integrated with handlebar 160 to form a unitary handlebar structure. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a first body portion opposing the first hand-gripping portion and a second body portion opposing the second hand-gripping portion, the first body portion is positioned and is shaped to receive so as to resist a leveraging force from a left-hand finger extended from a rider's left hand when on the first hand-gripping portion of the handlebar, and the second body portion is positioned and is shaped to receive so as to resist a leveraging force from a right-hand finger extended from a rider's right hand when on the second hand-gripping portion of the handlebar.

2. The handlebar assembly according to claim 1, wherein the first body portion is removably connected to the first hand-gripping portion of the handlebar, and the second body portion is removably connected to the second hand-gripping portion of the handlebar.

3. The handlebar assembly according to claim 1, wherein the first and second body portions are ahead of the handlebar and are inline with respect to the first and second handled ends.

4. The handlebar assembly according to claim 1, wherein the first and second body portions are ahead of the handlebar between the first and second handled ends, are inline with respect to the first and second handled ends, and are down-angled relative to the handlebar.

5. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a first body portion opposing the first hand-gripping portion and a second body portion opposing the second hand-gripping portion, the first body portion is positioned and is shaped to receive so as to resist a leveraging force from left-hand fingers extended from a rider's left hand when on the first hand-gripping portion of the handlebar, and the second body portion is positioned and is shaped to receive so as to resist a leveraging force from right-hand fingers extended from a rider's right hand when on the second hand-gripping portion of the handlebar.

6. The handlebar assembly according to claim 5, wherein the first body portion is removably connected to the first hand-gripping portion of the handlebar, and the second body portion is removably connected to the second hand-gripping portion of the handlebar.

7. The handlebar assembly according to claim 5, wherein the first and second body portions are ahead of the handlebar and are inline with respect to the first and second handled ends.

8. The handlebar assembly according to claim 5, wherein the first and second body portions are ahead of the handlebar between the first and second handled ends, are inline with respect to the first and second handled ends, and are down-angled relative to the handlebar.

9. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion and a second body portion opposing the second hand-gripping portion, the first body portion is positioned and is shaped to receive so as to resist a leveraging force from a left-hand finger extended from a rider's left hand when on the first hand-gripping portion of the handlebar, and the second body portion is positioned and is shaped to receive so as to resist a leveraging force from a right-hand finger extended from a rider's right hand when on the second hand-gripping portion of the handlebar.

10. The handlebar assembly according to claim 9, wherein the leveraging member is removably connected to the handlebar.

11. The handlebar assembly according to claim 9, wherein the first and second body portions of the leveraging member are ahead of the handlebar and are inline with respect to the first and second handled ends.

12. The handlebar assembly according to claim 11, wherein the leveraging member is parallel relative to the handlebar.

13. The handlebar assembly according to claim 9, wherein the first and second body portions are ahead of the handlebar between the first and second handled ends, are inline with respect to the first and second handled ends, and are down-angled relative to the handlebar.

14. The handlebar assembly according to claim 13, wherein the leveraging member is parallel relative to the handlebar.

15. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion and a second body portion opposing the second hand-gripping portion, the first body portion is positioned and is shaped to receive so as to resist a leveraging force from left-hand fingers extended from a rider's left hand when on the first hand-gripping portion of the handlebar, and the second body portion is positioned and is shaped to receive so as to resist a leveraging force from right-hand fingers extended from a rider's right hand when on the second hand-gripping portion of the handlebar.

16. The handlebar assembly according to claim 15, wherein the leveraging member is removably connected to the handlebar.

17. The handlebar assembly according to claim 15, wherein the first and second body portions of the leveraging member are ahead of the handlebar and are inline with respect to the first and second handled ends.

18. The handlebar assembly according to claim 17, wherein the leveraging member is parallel relative to the handlebar.

19. The handlebar assembly according to claim 15, wherein the first and second body portions are ahead of the handlebar between the first and second handled ends, are inline with respect to the first and second handled ends, and are down-angled relative to the handlebar.

20. The handlebar assembly according to claim 19, wherein the leveraging member is parallel relative to the handlebar.

21. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion, a second body portion opposing the second hand-gripping portion, and a middle between the first and second body portions, the first body portion has a first finger-engaging stall positioned and shaped to receive so as to resist a leveraging force from a left-hand finger extended from a rider's left hand when on the first hand-gripping portion of the handlebar, and the second body portion has a second finger-engaging stall positioned and shaped to receive so as to resist a leveraging force from a right-hand finger extended from a rider's right hand when on the second hand-gripping portion of the handlebar.

22. The handlebar assembly according to claim 21, wherein the leveraging member is removably connected to the handlebar.

23. The handlebar assembly according to claim 21, wherein the first finger-engaging stall and the second finger-engaging stall are each in-turned toward the middle.

24. The handlebar assembly according to claim 23, wherein the first and second body portions, including the first and second finger-engaging stalls, are ahead of the handlebar and are inline with respect to the first and second handled ends.

25. The handlebar assembly according to claim 24, wherein the leveraging member is parallel relative to the handlebar.

26. The handlebar assembly according to claim 23, wherein the first and second body portions, including the first and second finger-engaging stalls, are ahead of the handlebar, are inline with respect to the first and second handled ends, and are down-angled relative to the handlebar.

27. The handlebar assembly according to claim 26, wherein the leveraging member is parallel relative to the handlebar.

28. A handlebar assembly for a pedal-driven machine, especially a bicycle or a stationary bicycle or other like or similar stationary pedal-driven exercise machine, the handlebar assembly comprising a handlebar having an intermediate portion, first and second handled ends, a first hand-gripping portion on the handlebar between the intermediate portion and the first handled end, and a second hand-gripping portion on the handlebar between the intermediate portion and the second handled end, the handlebar assembly including a leveraging member including a first body portion opposing the first hand-gripping portion, a second body portion opposing the second hand-gripping portion, and a middle between the first and second body portions, the first body portion has a first row of first finger-engaging stalls positioned and shaped to receive so as to resist leveraging forces from left-hand fingers extended from a rider's left hand when on the first hand-gripping portion of the handlebar, and the second body portion has a second row of second finger-engaging stalls positioned and shaped to receive so as to resist leveraging forces from right-hand fingers extended from a rider's right hand when on the second hand-gripping portion of the handlebar.

29. The handlebar assembly according to claim 28, wherein the leveraging member is removably connected to the handlebar.

30. The handlebar assembly according to claim 28, wherein the first finger-engaging stalls are in-turned toward the middle, the second finger-engaging stalls are in-turned toward the middle, and the first finger-engaging stalls are inline with respect to the second finger-engaging stalls.

31. The handlebar assembly according to claim 30, wherein the first and second body portions, including the first finger-engaging stalls and the second finger-engaging stalls, are ahead of the handlebar and are inline with respect to the first and second handled ends.

32. The handlebar assembly according to claim 31, wherein the leveraging member is parallel relative to the handlebar.

33. The handlebar assembly according to claim 30, wherein the first and second body portions, including the first finger-engaging stalls and the second finger-engaging stalls, are ahead of the handlebar, are inline with respect to the first and second handled ends, and are down-angled relative to the handlebar.

34. The handlebar assembly according to claim 33, wherein the leveraging member is parallel relative to the handlebar.
